(19) United States
(12) Patent Application Publication
(10) Pub. No.: US 2022/0229687 A1
(43) Pub. Date: Jul. 21, 2022

(54) NON-DISRUPTIVE CONTAINER RUNTIME CHANGES

(71) Applicant: VMWARE, INC., Palo Alto, CA (US)

(72) Inventors: Prachi SINGHAL, Bangalore (IN); Akash KODENKIRI, Bangalore (IN); Sandeep SINHA, Bangalore (IN); Ammar RIZVI, Bangalore (IN)

(21) Appl. No.: 17/213,456

(22) Filed: Mar. 26, 2021

(30) Foreign Application Priority Data
Jan. 21, 2021 (IN) 202141002958

(51) Int. Cl. G06F 9/455

(52) U.S. Cl. CPC G06F 9/45558; G06F 2009/4557; G06F 2009/45595; G06F 2009/45562

(57) ABSTRACT

Methods, systems, and apparatus, including computer programs encoded on computer storage media, for migrating from a first container runtime to a second container runtime. One of the methods includes deploying a second control plane virtual machine that is configured to manage containers of a cluster of virtual execution environments using the second container runtime; obtaining, for each container executing workloads hosted by a respective virtual execution environment, a respective container image representing a current state of the container; updating each obtained container image to a format that is compatible with the second container runtime; deploying, for each updated container image, a corresponding container hosted by a virtual execution environment in the cluster, wherein the deployed container is managed by the second control plane virtual machine; decommissioning a first control plane virtual machine and transferring control of the containers of the cluster to the second control plane virtual machine.

### RELATED APPLICATIONS

Benefit is claimed under 35 U.S.C. 119(a)-(d) to Foreign Application Serial No. 202141002958 filed in India entitled “NON-DISRUPTIVE CONTAINER RUNTIME CHANGES”, on Jan. 21, 2021, by VMware, Inc., which is herein incorporated in its entirety by reference for all purposes.

### BACKGROUND

This specification generally relates to cloud computing platforms.

“Platform-as-a-Service” (commonly referred to as “PaaS”) technologies provide an integrated solution that enables a user to build, deploy, and manage a life cycle of cloud-based workloads, e.g., a web application or any other type of networked application. For brevity, in this specification, a PaaS system will also be referred to as a cloud computing platform or simply a platform. In this specification, a workload refers generally to one or more software tasks to be executed by a cloud computing platform. Typically supporting the cloud computing platform is an underlying cloud computing infrastructure that is operated and maintained by a service provider that may or may not be a different entity than the platform itself, e.g., an entity providing an infrastructure-as-a-service (“IaaS”) platform. The cloud computing platform thus functions as a software layer between the cloud computing infrastructure and the workloads executing on the infrastructure. The underlying cloud computing infrastructure includes hardware resources, e.g., processors or servers upon which workloads physically execute, as well as other resources, e.g. disks or networks that can be used by the workloads.

A developer using a cloud computing platform can leave logistics of provisioning and scaling hardware and software resources, e.g., processing power, facilities, power and bandwidth, data storage, or database access, to the cloud computing platform. By providing the hardware and software resources required to run a cloud based application, a cloud computing platform enables developers to focus on the development of an application itself.

### SUMMARY

This specification generally describes techniques for migrating a container runtime of a cloud computing platform.

Using techniques described in this specification, a system can migrate from a first container runtime to a second container runtime either “in-place,” where a control plane virtual machine that hosts the first container runtime is updated to support the second container runtime, or “side-by-side,” where a second control plane virtual machine is deployed that supports the second container runtime and control of the containers of the cloud computing platform is transferred from the first control plane virtual machine to the second control plane virtual machine.

In either implementation, migrating the container runtime can include updating one or more container orchestration components of the control plane virtual machine, updating one or more scripts executed by the control plane virtual machine, and/or updating container images of the containers executing workloads that are controlled by the control plane virtual machine.

Particular embodiments of the subject matter described in this specification can be implemented so as to realize one or more of the following advantages.

Using techniques described in this specification, a system can migrate the container runtime of a cloud computing platform without disrupting the workloads of the cloud computing platform. That is, during the migration, the workloads that are executing on respective virtual execution spaces of the cloud computing platform continue to execute without interruption, so that users of the cloud computing platform do not lose service at any time point. Executing a non-disruptive container runtime migration can be particularly important in situations where users are relying on the cloud computing platform to execute crucial workloads for which an interruption of service would have negative consequences, e.g., if the cloud computing platform is a PaaS solution that supports many users executing a wide variety of workloads.

The risk of service outages for running workloads can be a contributor to “vendor lock-in”, where a system cannot switch container runtimes without incurring significant switching costs, including time and computational costs for the migration and monetary costs incurred as a result of workload disruption. Therefore, the techniques described in this specification can allow the system to migrate to a preferred container runtime at a much lower switching cost.

Using techniques described in this specification, a cloud computing platform can migrate to a container runtime that is better suited for the particular needs of the cloud computing platform. Different container runtimes provide different advantages. For example, some container runtimes provide an expansive set of tools and functionalities for managing containers and container images that can be used in a wide variety of use cases. On the other hand, some other container runtimes provide a smaller set of functionalities that can be used to manage containers and container images in a more focused and efficient manner. As another example, some container runtimes provide more security than others, exposing the workloads to fewer cyberattacks. As another example, some container runtimes require the purchase of a license to user, while other container runtimes are entirely community-supported. As another example, some container runtimes provide lower latency than other runtimes.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example cloud computing environment.

FIG. 2 is a block diagram of an example cloud computing platform.

FIG. 3 is a block diagram of an example control plane virtual machine.

FIG. 4 is a block diagram of an example system for migrating the container runtime of a cloud computing platform from a first container runtime to a second container runtime.

FIG. 5 and FIG. 6 are flow diagrams of example processes for migrating the container runtime of a cloud computing platform from a first container runtime to a second container runtime.

Like reference numbers and designations in the various drawings indicate like elements.

### DETAILED DESCRIPTION

This specification describes techniques for migrating a container runtime of a cloud computing platform from a first container runtime to a second container runtime.

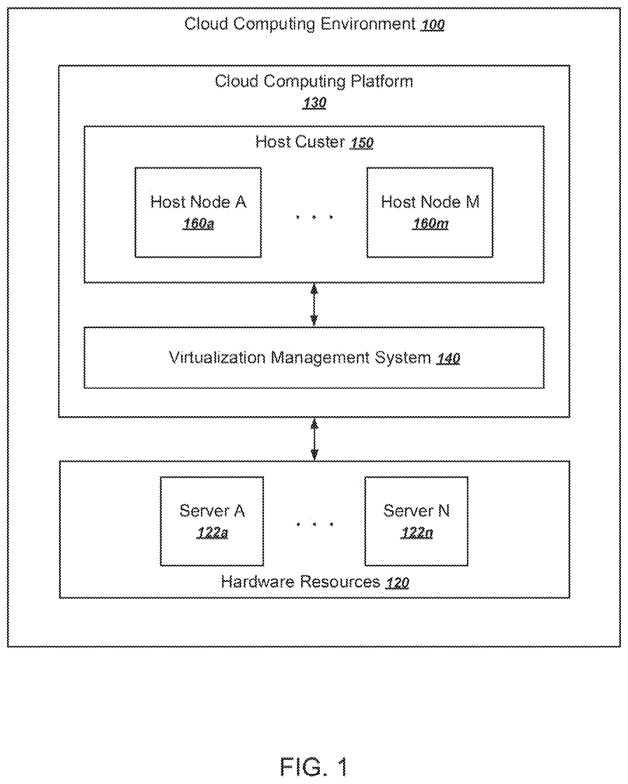

FIG. 1 is a block diagram of an example cloud computing environment 100. The cloud computing environment 100 includes a cloud computing platform 130 and hardware resources 120.

The hardware resources 120 include N servers 122a-n. The hardware resources 120 are typically hosted within a data center, which can be a distributed computing system having hundreds or thousands of computers in one or more locations.

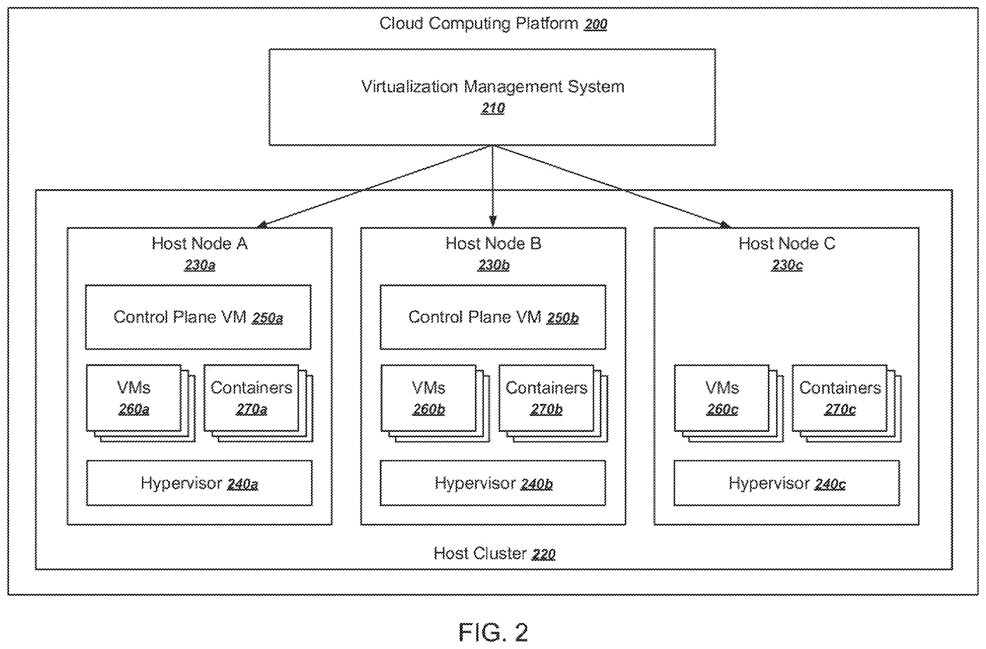

The cloud computing platform 130 includes a virtualization management system 140 and a host cluster 150. The host cluster 150 includes M nodes 160a-m, which are virtual execution environments that are each configured to execute one or more workloads. For example, the host cluster 150 can be a Kubernetes cluster, where the nodes 160a-m are configured to run containerized applications. The nodes 160a-m can be managed by a control plane, e.g., a control plane executed on a control plane virtual machine that is configured to execute a container runtime and that is hosted on one of the nodes 160a-m. This process is discussed in more detail below with reference to FIG. 2. As a particular example, the host cluster 150 can be a VSphere cluster, and each node 160a-m can be an ESXi node.

In some implementations, the cloud computing platform 130 can include multiple different host clusters 150 that are managed using respective different container runtimes. That is, a first host cluster 150 can be managed by a first control plane virtual machine executing a first container runtime, while a second host cluster 150 can be managed by a second control plane virtual machine executing a second container runtime. For example, the cloud computing platform 130 can support multiple different container runtimes, such that a user can select a particular container runtime when configuring a new host cluster 150. The user can subsequently decide to upgrade the selected container runtime of the new host cluster 150 or to migrate to a different container runtime supported by the cloud computing platform 130 without disrupting the workloads of the new host cluster 150.

The virtualization management system 140 is configured to manage the nodes 160a-m of the host cluster 150. From a single centralized location, the virtualization management system 140 can manage the execution of workloads on the host cluster 150. For example, the virtualization management system 140 can be a VCenter Server that is configured to manage the ESXi hosts of the host cluster 150.

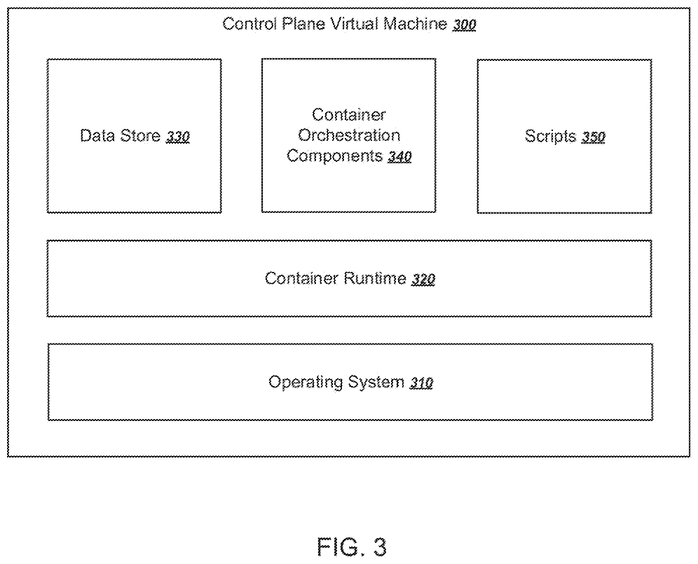

The virtualization management system 140 can be configured to upgrade the software resources of the host cluster 150. The virtualization management system 140 can further be configured to migrate the software resources of the host cluster 150 from a first software to a second software. For example, the virtualization management system 140 can migrate the container runtime of the host cluster 150. In this specification, a container runtime is software that executes containers and manages container images in a cloud computing environment. Example container runtimes include Docker Engine, containerd, Open Container Initiative (OCI), and rkt. Container runtimes are described in more detail below with reference to FIG. 3.

FIG. 2 is a block diagram of an example cloud computing platform 200. The cloud computing platform 200 is an example of a system implemented as computer programs on one or more computers in one or more locations, in which the systems, components, and techniques described below can be implemented.

The cloud computing platform 200 includes a virtualization management system 210 and a host cluster 220.

The host cluster 220 includes three virtualization execution environments, or “nodes” 230a-c. The nodes 230a-c are each configured to execute one or more workloads on respective containers or virtual machines. Although only three nodes are illustrated in FIG. 2, in general a host cluster 220 can include any number of nodes, e.g., 10, 100, or 1000.

Each node 230a-c can include a respective hypervisor 240a-c. Each hypervisor 240a-c is configured to generate and execute virtual machines on the corresponding node 230a-c. Each node 230a-c can also include one or more virtual machines 260a-c and/or containers 270a-c, which are each configured to execute workloads on the corresponding node 230a-c. In some implementations, the containers 270a-c of the respective nodes 230a-c are organized into one or more “pods,” where each pod includes one or more containers 270a-c and the containers 270a-c in the same pod share the same resources, e.g., storage and/or network resources.

One or more of the nodes 230a-c can also include a control plane virtual machine. In the example depicted in FIG. 2, the first node 230a includes a control plane virtual machine 250a and the second node 230b includes a control plane virtual machine 250b. Generally, any subset of the nodes of the host cluster 220 can include a respective control plane virtual machine. Each control plane virtual machine 250a-b is a virtual machine that is configured to manage the workloads that are executed in the virtual machines 260a-c and containers 270a-c of the nodes 230a-c of the host cluster 220.

In some implementations, one of the control plane virtual machines (e.g., the control plane virtual machine 250a of the first node 230a) is “active,” i.e., is currently controlling the host cluster 220, while one or more remaining control plane virtual machines (e.g., the control plane virtual machine 250b of the second node 230b) are “passive,” i.e., are not currently controlling the host cluster 220. If the active control plane virtual machine experiences a failure or otherwise goes offline, one of the passive control plane virtual machines can begin controlling the host cluster 220, thereby becoming the active control plane virtual machine.

Control plane virtual machines are discussed in more detail below with reference to FIG. 3.

FIG. 3 is a block diagram of an example control plane virtual machine 300. The control plane virtual machine 300 is an example of a system implemented as one or more computer programs on one or more computers in one or more locations, in which the systems, components, and techniques described below can be implemented.

The control plane virtual machine is configured to manage the workloads of a cluster of virtual execution environments, e.g., the host cluster 220 depicted in FIG. 2. The control plane virtual machine 300 includes an operating system 310, a container runtime 320, a data store 330, a set of container orchestration components 340, and a set of scripts 350.

The operating system 310 can be any appropriate operating system that enables the control plane virtual machine 300 to manage workloads. For example, the operating system 310 can be the Photon OS operating system.

As described above, container runtime 320 executes the containers and manages the container images of the virtual execution environments.

The data store 330 is configured to maintain data for the workloads that are executing on the virtual execution environments. The data store 330 can store data that represents the current state of one or more components of the container orchestration components 340. For example, the data store 330 can store configuration details and metadata for the components of the container orchestration components 340. As another example, the data store 330 can store a “desired” sate for one or more components of the container orchestration components 340. If at any point the current state of a component and the desired state of the component does not match, then the control plane virtual machine 300 (or a virtualization management system for the control plane virtual machine 300, e.g., the virtualization management system 210 depicted in FIG. 2) can take action to reconcile the difference. In some implementations, the data store 330 can be a key-value store, e.g., the etcd data store.

The set of container orchestration components 340 includes one or more software components that the control plane virtual machine 300 uses to execute the workloads of the virtual execution environments. For example, the container orchestration components 340 can include an API server for the API of a container orchestration platform used by the control plane virtual machine 300; as a particular example, the container orchestration components 340 can include a kube-apiserver for the Kubernetes API. As another example, the container orchestration components 340 can include a scheduler that assigns new workloads to respective virtual execution environments; as a particular example, the container orchestration components 240 can include a kube-scheduler.

The set of scripts 350 includes one or more scripts that can be executed by the control plane virtual machine 300 to control the virtual execution environment. For example, the scripts 350 can include one or more “bootstrap” scripts for deploying new virtual execution environments on the cluster. As a particular example, the scripts 350 can include one or more scripts related to kubeadm, which is a tool configured to bootstrap a minimum viable cluster of nodes. As other particular examples, the scripts 350 can includes one or more scripts related to cluster configuration, generating certificates for the cluster, and/or setting up and configuring the data store 330.

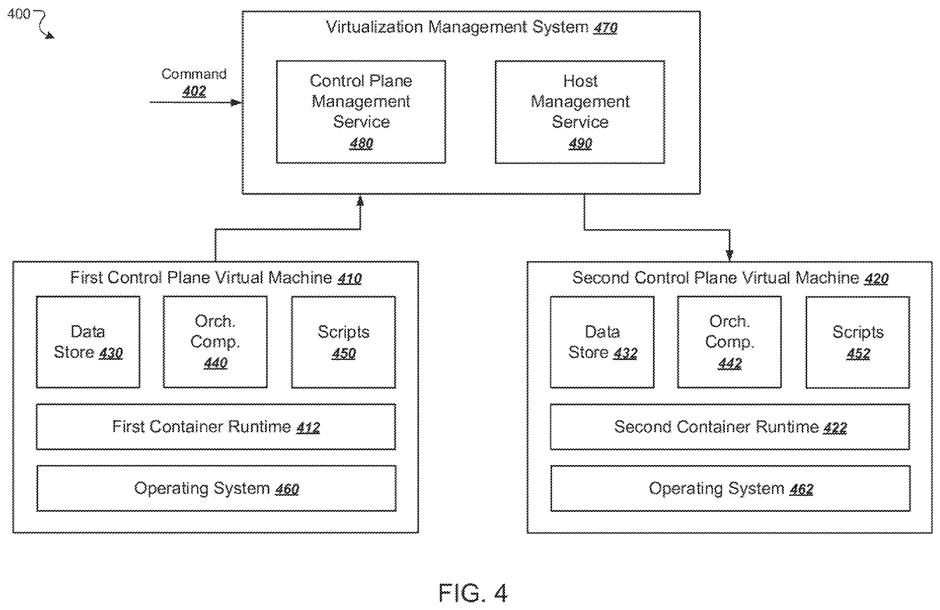

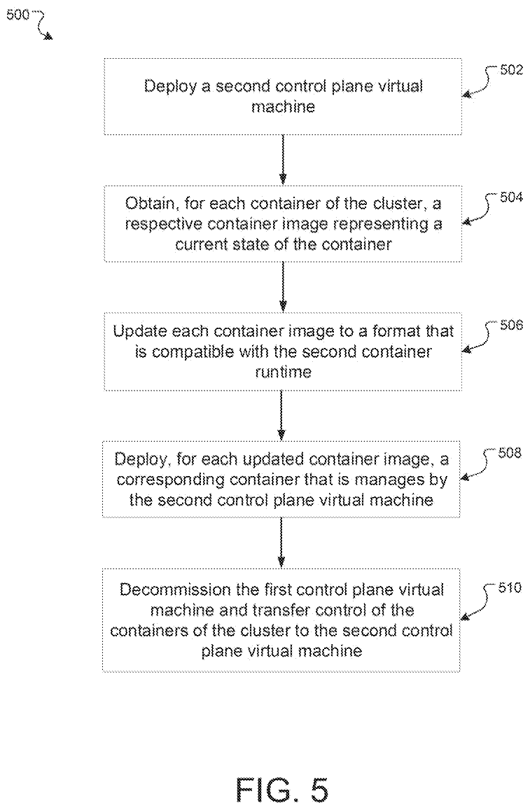

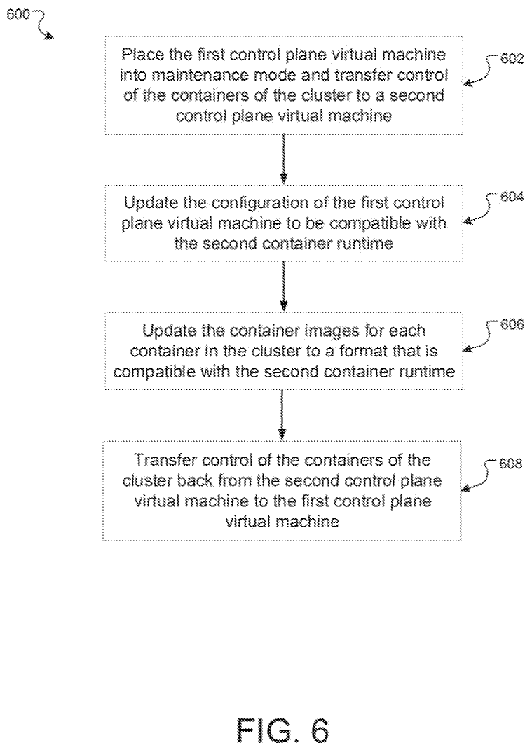

FIG. 4, FIG. 5, and FIG. 6 illustrate example systems and processes for migrating the container runtime of a cluster of virtual execution environments from a first container runtime to a second container runtime. FIG. 4 and FIG. 5 illustrate an example system and process, respectively, for migrating the container runtime “side-by-side,” i.e., by maintaining a first virtual machine that executes the first container runtime while setting up a second virtual machine that executes the second container runtime, and then transferring control from the first virtual machine to the second virtual machine. FIG. 6 illustrates an example process for migrating the container runtime “in-place,” i.e., by setting up the second container runtime to be executed on the same virtual machine that is executing the first container runtime.

FIG. 4 is a block diagram of an example system 400 for migrating the container runtime of a cloud computing platform from a first container runtime 412 to a second container runtime 422.

The system 400 is configured to migrate the container runtime without interrupting the workloads currently running on the cloud computing platform. As described above, the cloud computing platform might be a PaaS solution that allows customers to execute workloads on the cloud computing platform; in these cases, customers rely on the platform to ensure that important workloads execute successfully, so it is important that this service is not interrupted during the migration.

The system includes a first control plane virtual machine 410, a second control plane virtual machine 420, and a virtualization management system 470. Before the migration of the container runtime, the first control plane virtual machine 410 manages the workloads executed on a cluster of virtual execution spaces of the cloud computing platform, using the first container runtime 412. As described above, the first control plane virtual machine 410 includes a data store 430, a set of container orchestration components 440, a set of scripts 450, and an operating system 460.

Upon receiving a command 402 to migrate the container runtime, the virtualization management system 470 commissions the second control plane virtual machine 420, which is configured to manage the workloads on the cluster of virtual execution spaces using the second container runtime 422. While the virtualization management system 470 is in the process of commissioning the second control plane virtual machine 420, the first control plane virtual machine 410 continues to manage the cluster using the first container runtime 412.

The virtualization management system 470 includes a control plane management service 480 and a host management service 490. The control plane management service 480 is configured to manage the lifecycle of a control plane virtual machine, including commissioning a new control plane virtual machine when migrating the container runtime. For example, the control plane management service 480 can be a Workload Control Plane (WCP) controller. The host management service 490 is configured to execute the deployment of containers and/or virtual machines within the virtual execution spaces of the cluster. For example, the host management service 490 can be an ESX Agent Manager (EAM).

When the virtualization management system 470 receives the command 402 to migrate the container runtime, the control plane management service 480 can call the host management service 490 to deploy the second control plane virtual machine 420. The virtualization management system 470 can then configure the deployed second control plane virtual machine 420 to act as the control plane of the cluster of virtual execution spaces. In some implementations, the host management service 490 deploys the second control plane virtual machine 420 with an operating system 462 that is the same as the operating system 460 of the first control plane virtual machine 410. In some other implementations, the host management service 490 deploys the second control plane virtual machine 420 with a different operating system 462 than the operating system 460 of the first control plane virtual machine, e.g., an operating system that supports, or better supports, the second container runtime 422.

To configure the second control plane virtual machine 420, the virtualization management system 470 can obtain the current configuration of the first control plane virtual machine 410. For example, the virtualization management system 470 can send a request to the first control plane virtual machine 410 to provide the current configuration, which can, e.g., be stored by the data store 430. As another example, the virtualization management system 470 can always maintain data characterizing the current configuration of the first control plane virtual machine 410. After obtaining the current configuration, the virtualization management system 470 can synchronize the configuration of the second control plane virtual machine 420 so that it matches the current configuration of the first control plane virtual machine 410. For example, the current configuration can include a respective current state for each component in the set of container orchestration components 440 of the first control plane virtual machine 410, and can use the current configuration to launch a corresponding set of container orchestration components 442 in the second control plane virtual machine 420 that each have the same current state defined by the current configuration.

In some implementations, the virtualization management system 470 obtains the current state of each workload executing in the cluster of virtualization execution environments. For example, the data store 430 of the first control plane virtual machine 410 can maintain the container image for each container executing workloads in the cluster. The virtualization management system 470 can obtain each container image from the data store 430 of the first control plane virtual machine 410, and use the second container runtime 422 to deploy, for each workload executing in the cluster, a corresponding new workload controlled by the second control plane virtual machine 420. The second container runtime 422 can use the container images to deploy the new workloads, and store the container images in the data store 432 of the second control plane virtual machine 420. In some other implementations, the second container runtime 422 obtains the current state of each workload itself, without the virtualization management system 470 acting as an intermediary. For example, the second container runtime 422 can obtain each container image directly from the data store 430 of the first control plane virtual machine 410, use the container images to deploy new workloads controlled by the second control plane virtual machine 420, and store the container images in the data store 432 of the second control plane virtual machine 420.

In some implementations, the container images supported by the first container runtime 412 have a different format than the container images supported by the second container runtime 422. In these implementations, after obtaining the container images of the containers being controlled by the first control plane virtual machine 410 from the data store 430, the virtualization management system 470 (or the second container runtime 422 itself) can convert the obtained container images into a format that is compatible with the second container runtime 422. For example, the virtualization management system 470 can update an image manifest that identifies information about the configuration of one or more of the container images. For example, the image manifest can identify the size of the container image, the layers of the container image, and/or a digest of the container image. As a particular example, the virtualization management system 470 (or the second container runtime 422 itself) can update the version or schema of the image manifest.

In some implementations, the virtualization management system 470 can further obtain any other data stored in the data store 430 of the first control plane virtual machine 410, and copy the data to the data store 432 of the second control plane virtual machine 420. In some other implementations, the second control plane virtual machine 420 can obtain the data from the data store 430 itself, as described above. As particular examples, the virtualization management system 470 can transfer, from the first control plane virtual machine 410 to the second control plane virtual machine, data related to local registry repos, namespaces, and tags associated with container images.

The virtualization management system 470 can obtain the set of scripts 450 being executed by the first control plane virtual machine 410, and launch a corresponding set of scripts 452 onto the second control plane virtual machine 420. In some implementations, the two sets of scripts 450 and 452 are the same. In some other implementations, the virtualization management system 470 updates one or more scripts in the set of scripts 450 before deploying them onto the second control plane virtual machine 420, e.g., updating the scripts to be compatible with the second container runtime 422. For example, in some implementations, one or more of the scripts 450 of the first control plane virtual machine can include conditional checks that determine the current container runtime and, based on the current container runtime, execute commands specifically configured for the current container runtime. In these implementations, the virtualization management system 470 can insert, or update, commands corresponding to the second container runtime 422.

In some implementations, during the transition from the first control plane virtual machine 410 to the second control plane virtual machine 420, the cloud computing platform supports both the first container runtime 412 and the second container runtime 422. For example, one or more components in the two sets of container orchestration components 440 and 442 can be the same. When interacting with workloads executing in the cluster during the transition, the one or more components can communicate with both the first container runtime 412 and the second container runtime 422, e.g., when migrating the workloads from the first control plane virtual machine 410 to the second control plane virtual machine. The virtualization management system 470 can send a notification to the one or more components alerting the components that they will receive communications from both container runtimes 412 and 422.

After the virtualization management system 470 completes the configuration of the second control plane virtual machine 420, the virtualization management system 470 can decommission the first control plane virtual machine 410 and transfer the control of the workloads executing on the cluster of virtual execution environments to the second control plane virtual machine 420.

FIG. 5 is a flow diagram of an example process 500 for migrating the container runtime of a cloud computing platform from a first container runtime to a second container runtime. For convenience, the process 500 will be described as being performed by a system of one or more computers located in one or more locations. For example, a virtualization management system, e.g., the virtualization management system 140 depicted in FIG. 1, appropriately programmed in accordance with this specification, can perform the process 500.

The cloud computing platform can include a cluster of virtual execution environments that are each configured to execute workloads on containers hosted by the virtual execution environment. A particular virtual execution environment can include a first control plane virtual machine that is configured to manage the containers of the cluster using the first container runtime.

The system deploys a second control plane virtual machine that is configured to manage the containers of the cluster using the second container runtime (step 502). For example, the system can obtain the current configuration of the first control plane virtual machine, and synchronize the current configuration of the second control plane virtual machine with the current configuration of the first control plane virtual machine.

The system obtains, for each container executing workloads hosted by a respective virtual execution environment in the cluster, a respective container image representing a current state of the container (step 504). In some implementations, the container images are in a format that is compatible with the first container runtime but not compatible with the second container runtime.

In these implementations, the system updates each obtained container image to a format that is compatible with the second container runtime (step 506).

The system deploys, for each updated container image, a corresponding container hosted by a virtual execution environment in the cluster, where the deployed container is managed by the second control plane virtual machine (step 508).

The system decommissions the first control plane virtual machine and transfers control of the containers of the cluster to the second control plane virtual machine (step 510).

FIG. 6 is a flow diagram of an example process 600 for migrating the container runtime of a cloud computing platform from a first container runtime to a second container runtime. For convenience, the process 600 will be described as being performed by a system of one or more computers located in one or more locations. For example, a virtualization management system, e.g., the virtualization management system 140 depicted in FIG. 1, appropriately programmed in accordance with this specification, can perform the process 600.

The cloud computing platform can include a cluster of virtual execution environments that are each configured to execute workloads on containers hosted by the virtual execution environment. A particular virtual execution environment can include a first control plane virtual machine that is configured to manage the containers of the cluster using the first container runtime, while one or more other virtual execution environments can include respective second control plane virtual machines. The first control plane virtual machine can be active, while each second control plane virtual machine can be passive, as described above.

The system places the first control plane virtual machine into “maintenance mode,” and transfers control of the containers of the cluster to one of the second control plane virtual machines (step 602). In other words, the second control plane virtual machine becomes active, and the first control plane virtual machine becomes passive.

The system updates the configuration of the first control plane virtual machine to be compatible with the second container runtime (step 604). For example, as described above, the system can update one or more container orchestration components to accept communications from the second container runtime instead or in addition to the first container runtime.

The system updates the container images for each container in the cluster to a format that is compatible with the second container runtime (step 606). For example, as described above, the system can update an image manifest, e.g., by updating a schema of the manifest, that identifies information about the container images of the containers.

In some implementations, the system can further perform other updates, as described above. For example, the system can update one or more scripts of the first control plane virtual machine to be compatible with the second container runtime.

The system transfers control of the containers of the cluster back from the second control plane virtual machine to the first control plane virtual machine (step 608). That is, the first control plane virtual machine again becomes active, and the second control plane virtual machine again become passive. Because the second container runtime is now deployed on the first control plane virtual machine, control of the containers is thus transferred to the second container runtime.

In some implementations, an in-place migration might be preferable to a side-by-side migration. For example, a side-by-side migration, e.g., as implemented using the process described above with reference to FIG. 5, can require more network resources to execute because it requires transferring data (e.g., container images and configuration data) from a first control plane virtual machine to a second control plane virtual machine. Therefore, a side-by-side migration might not be suitable for environments in which network resources are limited, e.g., when the bandwidth of the network cannot handle such a migration.

In some other implementations, a side-by-side migration might be preferable to an in-place migration. For example, in some cases an in-place migration can introduce a higher likelihood that the data of the control plane virtual machine (e.g., one or more container images or configuration data) becomes corrupted because the data is being overwritten in a single location.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; solid state drives, NVMe devices, persistent memory devices, magnetic disks, e.g., internal hard disks or removable disks; magneto-optical disks; and CD-ROM and DVD-ROM and Blu-ray discs. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communications network. Examples of communications networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method of migrating a container runtime of a cloud computing platform from a first container runtime to a second container runtime, wherein the cloud computing platform comprises:
a cluster comprising a plurality of virtual execution environments, wherein each virtual execution environment is configured to execute workloads on containers hosted by the virtual execution environment, and wherein a particular virtual execution environment comprises a first control plane virtual machine that is configured to manage the containers of the cluster using the first container runtime, and
a virtualization management system that is configured to manage the plurality of virtual execution environments of the cluster,

the method comprising:

deploying, by the virtualization management system, a second control plane virtual machine that is configured to manage the containers of the cluster using the second container runtime;

obtaining, for each container executing workloads hosted by a respective virtual execution environment in the cluster, a respective container image representing a current state of the container;

updating each obtained container image to a format that is compatible with the second container runtime;

deploying, for each updated container image, a corresponding container hosted by a virtual execution environment in the cluster, wherein the deployed container is managed by the second control plane virtual machine; and

decommissioning the first control plane virtual machine and transferring control of the containers of the cluster to the second control plane virtual machine.

Embodiment 2 is the method of embodiment 1, wherein deploying the second control plane virtual machine comprises:

obtaining, from a data store of the first control plane virtual machine, a current configuration of the first control plane virtual machine; and

synchronizing a current configuration of the second control plane virtual machine with the current configuration of the first control plane virtual machine;

Embodiment 3 is the method of any one of embodiments 1 or 2, wherein the current configuration of the first control plane virtual machine comprises data representing a respective current state of each of a plurality of container orchestration components of the first control plane virtual machine.

Embodiment 4 is the method of any one of embodiments 1-3, further comprising:

obtaining a plurality of scripts executed by the first control plane virtual machine to manage the containers of the cluster;

updating the plurality of scripts to be compatible with the second container runtime; and

deploying the updated plurality of scripts on the second control plane virtual machine.

Embodiment 5 is the method of embodiment 4, wherein updating a particular script comprises updating a conditional statement to insert or update one or more commands corresponding to the second container runtime.

Embodiment 6 is the method of any one of embodiments 1-5, wherein the virtualization management system comprises:

a control plane management service that is configured to manage lifecycles of control plane virtual machines of the cluster; and

a host management service that is configured to deploy virtual machines within virtual execution spaces of the cluster.

Embodiment 7 is the method of any one of embodiments 1-6, wherein updating a particular container image comprises updating a schema of a manifest of the particular container image.

Embodiment 8 is a system comprising: one or more computers and one or more storage devices storing instructions that are operable, when executed by the one or more computers, to cause the one or more computers to perform the method of any one of embodiments 1 to 7.

Embodiment 9 is one or more non-transitory computer storage media encoded with a computer program, the program comprising instructions that are operable, when executed by data processing apparatus, to cause the data processing apparatus to perform the operations of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, the subject matter is described in context of scientific papers. The subject matter can apply to other indexed work that adds depth aspect to a search. In some cases, the actions recited in the claims can be performed in a different order and still achieve desirable results. In addition, the processes described do not necessarily require the particular order shown, or sequential order, to achieve desirable results. In certain implementations, multitasking and parallel processing can be advantageous.

What is claimed is:

1. A method of migrating a container runtime of a cloud computing platform from a first container runtime to a second container runtime, wherein the cloud computing platform comprises:
a cluster comprising a plurality of virtual execution environments, wherein each virtual execution environment is configured to execute workloads on containers hosted by the virtual execution environment, and wherein a particular virtual execution environment comprises a first control plane virtual machine that is configured to manage the containers of the cluster using the first container runtime, and
a virtualization management system that is configured to manage the plurality of virtual execution environments of the cluster,
the method comprising:
deploying, by the virtualization management system, a second control plane virtual machine that is configured to manage the containers of the cluster using the second container runtime;
obtaining, for each container executing workloads hosted by a respective virtual execution environment in the cluster, a respective container image representing a current state of the container;
updating each obtained container image to a format that is compatible with the second container runtime;
deploying, for each updated container image, a corresponding container hosted by a virtual execution environment in the cluster, wherein the deployed container is managed by the second control plane virtual machine; and
decommissioning the first control plane virtual machine and transferring control of the containers of the cluster to the second control plane virtual machine.

2. The method of claim 1, wherein deploying the second control plane virtual machine comprises:
obtaining, from a data store of the first control plane virtual machine, a current configuration of the first control plane virtual machine; and
synchronizing a current configuration of the second control plane virtual machine with the current configuration of the first control plane virtual machine;

3. The method of claim 1, wherein the current configuration of the first control plane virtual machine comprises data representing a respective current state of each of a plurality of container orchestration components of the first control plane virtual machine.

4. The method of claim 1, further comprising:
obtaining a plurality of scripts executed by the first control plane virtual machine to manage the containers of the cluster;
updating the plurality of scripts to be compatible with the second container runtime; and
deploying the updated plurality of scripts on the second control plane virtual machine.

5. The method of claim 4, wherein updating a particular script comprises updating a conditional statement to insert or update one or more commands corresponding to the second container runtime.

6. The method of claim 1, wherein the virtualization management system comprises:
a control plane management service that is configured to manage lifecycles of control plane virtual machines of the cluster; and
a host management service that is configured to deploy virtual machines within virtual execution spaces of the cluster.

7. The method of claim 1, wherein updating a particular container image comprises updating a schema of a manifest of the particular container image.

8. A system comprising one or more computers and one or more storage devices storing instructions that are operable, when executed by the one or more computers, to cause the one or more computers to perform operations for migrating a container runtime of a cloud computing platform from a first container runtime to a second container runtime, wherein the cloud computing platform comprises:
a cluster comprising a plurality of virtual execution environments, wherein each virtual execution environment is configured to execute workloads on containers hosted by the virtual execution environment, and wherein a particular virtual execution environment comprises a first control plane virtual machine that is configured to manage the containers of the cluster using the first container runtime, and
a virtualization management system that is configured to manage the plurality of virtual execution environments of the cluster,
the operations comprising:
deploying, by the virtualization management system, a second control plane virtual machine that is configured to manage the containers of the cluster using the second container runtime;
obtaining, for each container executing workloads hosted by a respective virtual execution environment in the cluster, a respective container image representing a current state of the container;
updating each obtained container image to a format that is compatible with the second container runtime;
deploying, for each updated container image, a corresponding container hosted by a virtual execution environment in the cluster, wherein the deployed container is managed by the second control plane virtual machine; and
decommissioning the first control plane virtual machine and transferring control of the containers of the cluster to the second control plane virtual machine.

9. The system of claim 8, wherein deploying the second control plane virtual machine comprises:
obtaining, from a data store of the first control plane virtual machine, a current configuration of the first control plane virtual machine; and
synchronizing a current configuration of the second control plane virtual machine with the current configuration of the first control plane virtual machine;

10. The system of claim 8, wherein the current configuration of the first control plane virtual machine comprises data representing a respective current state of each of a plurality of container orchestration components of the first control plane virtual machine.

11. The system of claim 8, the operations further comprising:
obtaining a plurality of scripts executed by the first control plane virtual machine to manage the containers of the cluster;
updating the plurality of scripts to be compatible with the second container runtime; and
deploying the updated plurality of scripts on the second control plane virtual machine.

12. The system of claim 11, wherein updating a particular script comprises updating a conditional statement to insert or update one or more commands corresponding to the second container runtime.

13. The system of claim 8, wherein the virtualization management system comprises:
a control plane management service that is configured to manage lifecycles of control plane virtual machines of the cluster; and
a host management service that is configured to deploy virtual machines within virtual execution spaces of the cluster.

14. The system of claim 8, wherein updating a particular container image comprises updating a schema of a manifest of the particular container image.

15. One or more non-transitory storage media storing instructions that when executed by one or more computers cause the one or more computers to perform operations for migrating a container runtime of a cloud computing platform from a first container runtime to a second container runtime, wherein the cloud computing platform comprises:
a cluster comprising a plurality of virtual execution environments, wherein each virtual execution environment is configured to execute workloads on containers hosted by the virtual execution environment, and wherein a particular virtual execution environment comprises a first control plane virtual machine that is configured to manage the containers of the cluster using the first container runtime, and
a virtualization management system that is configured to manage the plurality of virtual execution environments of the cluster,
the operations comprising:
deploying, by the virtualization management system, a second control plane virtual machine that is configured to manage the containers of the cluster using the second container runtime;
obtaining, for each container executing workloads hosted by a respective virtual execution environment in the cluster, a respective container image representing a current state of the container;
updating each obtained container image to a format that is compatible with the second container runtime;
deploying, for each updated container image, a corresponding container hosted by a virtual execution environment in the cluster, wherein the deployed container is managed by the second control plane virtual machine; and
decommissioning the first control plane virtual machine and transferring control of the containers of the cluster to the second control plane virtual machine.

16. The non-transitory storage media of claim 15, wherein deploying the second control plane virtual machine comprises:
obtaining, from a data store of the first control plane virtual machine, a current configuration of the first control plane virtual machine; and
synchronizing a current configuration of the second control plane virtual machine with the current configuration of the first control plane virtual machine;

17. The non-transitory storage media of claim 15, wherein the current configuration of the first control plane virtual machine comprises data representing a respective current state of each of a plurality of container orchestration components of the first control plane virtual machine.

18. The non-transitory storage media of claim 15, the operations further comprising:
obtaining a plurality of scripts executed by the first control plane virtual machine to manage the containers of the cluster;
updating the plurality of scripts to be compatible with the second container runtime; and
deploying the updated plurality of scripts on the second control plane virtual machine.

19. The non-transitory storage media of claim 18, wherein updating a particular script comprises updating a conditional statement to insert or update one or more commands corresponding to the second container runtime.

20. The non-transitory storage media of claim 15, wherein the virtualization management system comprises:
a control plane management service that is configured to manage lifecycles of control plane virtual machines of the cluster; and
a host management service that is configured to deploy virtual machines within virtual execution spaces of the cluster.
